(19) United States
(12) Patent Application Publication
(10) Pub. No.: US 2007/0006927 A1
(43) Pub. Date: Jan. 11, 2007

(54) Apparatus for discharging fluid

(75) Inventors: Dale Wilbert Dallmann, Greenville, WI (US); Robert Paul Juidici, New London, WI (US); Ryan David Julius, Appleton, WI (US)

Correspondence Address: FOLEY & LARDNER LLP, 777 EAST WISCONSIN AVENUE, MILWAUKEE, WI, 53202-5306, US

(73) Assignee: Oshkosh Truck Corporation

(21) Appl. No.: 11/174,880

(22) Filed: Jul. 5, 2005

(51) Int. Cl. B60P 3/30

(52) U.S. Cl. 137/899

(57) ABSTRACT

An apparatus for discharging fluid from a container. The apparatus comprises a mounting member coupled to the container. A valve is coupled to the mounting member and selectively in fluid communication with the container. A swivel, including a single ninety-degree elbow member, is coupled to the mounting member and the valve. A chute is coupled to the swivel, wherein the chute is pivotable in an arc to any side of the container.

### FIELD OF THE INVENTION

The present invention relates generally to the field of fluid valves, and more particularly to an apparatus for discharging fluid from a container, with the apparatus configured to swivel beneath the container to any side of the container.

### BACKGROUND OF THE INVENTION

In certain circumstances, it may be necessary to discharge fluid from a container very quickly. Such situations rise with fire fighting equipment where water in a tanker truck or trailer needs to be discharged quickly. It is known to use what is referred to as a “dump valve” which when opened will allow fluid, such as water, to flow through a chute coupled to the valve apparatus. A typical arrangement for such dump chute is to have a drop box mounted on the tank, usually on the bottom of the tank, with a series of 90 degree elbow members coupling a chute to the drop box and valve apparatus. A disadvantage of such arrangement is the chute typically is directed to only one side of the container, for example, either the left side or right side of the container mounted on the vehicle. Another arrangement provides for the dump valve to be mounted directly to the container typically at the side of the container (in a vertical orientation) with a number of elbow members used to direct the chute orientation. Again, this arrangement limits the direction of the chute discharge to only one side of the container. To discharge fluid to another orientation, the vehicle either has to be turned or additional valving apparatuses have to be coupled to the container on another side of the container.

Thus, there is a need for an apparatus for discharging fluid from a container wherein the chute is pivotable in an arc to any side of the container. There is also a need for an apparatus for discharging fluid from a container that includes a single 90 degree elbow member for directing the fluid.

### SUMMARY OF THE INVENTION

There is provided an apparatus for discharging fluid from a container. The apparatus comprises a mounting member coupled to the container. A valve is coupled to the mounting member and selectively in fluid communication with the container. A swivel, including a ninety-degree elbow member, is coupled to the mounting member and the valve. A chute is coupled to the swivel, wherein the chute is pivotable in an arc to any side of the container. Another embodiment provides a telescopic chute.

There is further provided a vehicle comprising a support structure. A plurality of wheels are coupled to the support structure with at least two of the wheels steerable. A container is mounted on the support structure. An apparatus for discharging fluid from the container is coupled to the container. The apparatus comprises a mounting member coupled to the container. A valve is coupled to the mounting member and selectively in fluid communication with the container. A swivel, including a ninety-degree elbow member, is coupled to the mounting member and the valve. A chute is coupled to the swivel, wherein the chute is pivotable in an arc to any side of the container. Another embodiment provides a telescopic chute.

There is further provided a fluid hauling vehicle comprising a tank for storing at least 1000 gallons of fluid, the tank including a discharge port configured to permit at least 800 gallons per minute of fluid flow from the port when the fluid flow is caused by gravity. A rotating chute coupled to the port configured to permit directing fluid flow in a range of directions relative to the tank wherein at least two of the directions are defined by rotating the chute in at least two positions offset from each other by at least 145 degrees.

### BRIEF DESCRIPTION OF THE DRAWINGS

FIG. 1 is a partial rear plan view of a vehicle including a container having an exemplary embodiment of an apparatus for discharging fluid from the container.

FIG. 2 is a top plan view of the apparatus illustrated in FIG. 1 along the line 2-2.

FIG. 3 is a top detail view of the apparatus illustrated in FIG. 2.

FIG. 4 is a sectional perspective view of an exemplary embodiment of an apparatus for discharging fluid from a container.

### DETAILED DESCRIPTION OF THE EXEMPLARY EMBODIMENTS

Referring to the figures, when referring to a vehicle 10, it is contemplated that a vehicle 10 can be of several different uses and is referred to as a work vehicle 10, a fire fighting vehicle 10, a crash truck 10, a multi-wheel vehicle 10 and the like. It is also contemplated that articulated tracks mounted on the wheels 14 can be used as a support for the support structure 12 of a vehicle 10. It is contemplated that any convenient and conventional materials can be utilized for such vehicle 10 commensurate with the type of duty that will be experienced by such vehicle 10. For example, the vehicle 10 can be made out of steel, aluminum, or composite materials. The wheels 12 can be cast or machined, etc.

The container 16 can be mounted directly on a vehicle 10, can be towed on a separate trailer structure, or can be a fixed fluid source such as a tank. For example, if the vehicle 10 is configured as a fire fighting vehicle, the container 16 is typically mounted on the vehicle 10.

The vehicle 10, when configured as a truck, such as a tanker truck, typically will have two steerable wheels. The steerable wheels typically will be the front-most pair, however, it is also contemplated that more wheel pairs may be steerable, for example, the rear-most wheels may be steerable.

A power source 11 coupled to at least one wheel 14 drives the vehicle 10 along a surface S. It should be understood that the power source 11 can be an electric motor coupled to each wheel 14, or an internal combustion engine coupled to wheel sets through an appropriate transmission, differential and gear train. Other motive arrangements, for example a hybrid system, can also be used to move the vehicle.

Referring to the Figures, FIG. 1 is an exemplary embodiment of a vehicle 10 comprising a support structure 12. A plurality of wheels 14 are coupled to the support structure 12 with at least two of the wheels 14 steerable. The support structure 12 can be a chassis frame and appropriate suspension apparatus coupling the support structure 12 to the wheel sets. A container 16, also referred to as a tank, is mounted on the support structure 12. The container 16 can be, for example, a tank configured in a box-like structure or any other appropriate tank configuration. Baffles inside the tank may or may not be provided. The container 16 can be composed of metal such as steel or aluminum or it can be a composite material such as fiberglass or carbon impregnated plastic or the like. The container 16 can be configured to contain fluid ranging from 1000 gallons to 5000 gallons or more. A typical container 16 size on a fire-fighting vehicle is 2100 gallons or 3000 gallons.

An apparatus 20 for discharging fluid from the container 16 is coupled to the container 16, for example, at the lowest portion 18 of the container at a discharge port 15 (See FIG. 1). The discharge port can be configured to provide fluid flow range of 800 gallons per minute to 2000 gallons per minute. The flow rate is typically based on fluid flow caused by gravity. For example, a flow rate of about 1700 gallons per minute can be achieved from a 2100 gallon tank with a 10 inch inside diameter chute coupled to the tank. Higher flow rates can be achieved with pumps or changing certain dimensions of the tank.

A mounting member 22 is coupled to the container 16 with a plurality of appropriate fasteners. A valve 26 is coupled to the mounting member 22 and selectively in fluid communication with the container 16. The valve 26 can be any type of appropriate valve, however, a preferred valve is a butterfly valve 27. The valve 26 is actuated by a valve handle 28 which can be manipulated manually, or coupled to an actuator such as a hydraulic cylinder or an electric motor or the like. Control of the valve 26 can be affected directly by an operator manipulating the valve 26 or remotely such as from the cab of the vehicle 10 or by a hand held remote control device.

A swivel 30 which includes a single 90-degree elbow member 32 is coupled to the mounting member 22 and the valve 26. The elbow member 32 can be configured with an elbow angle with a range of 75 degrees to 90 degrees with an inside diameter at least as large as the chute diameter.

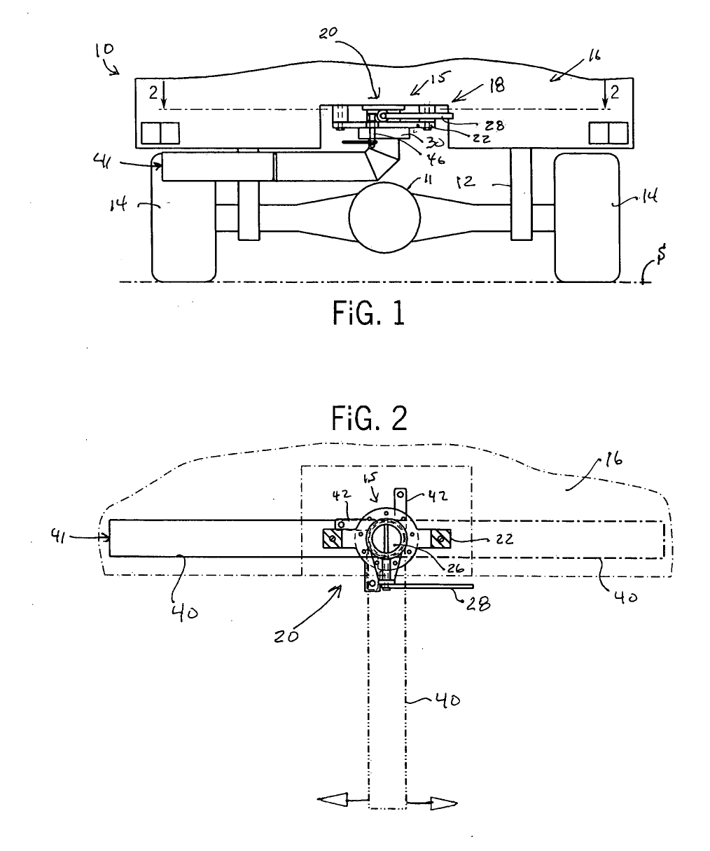

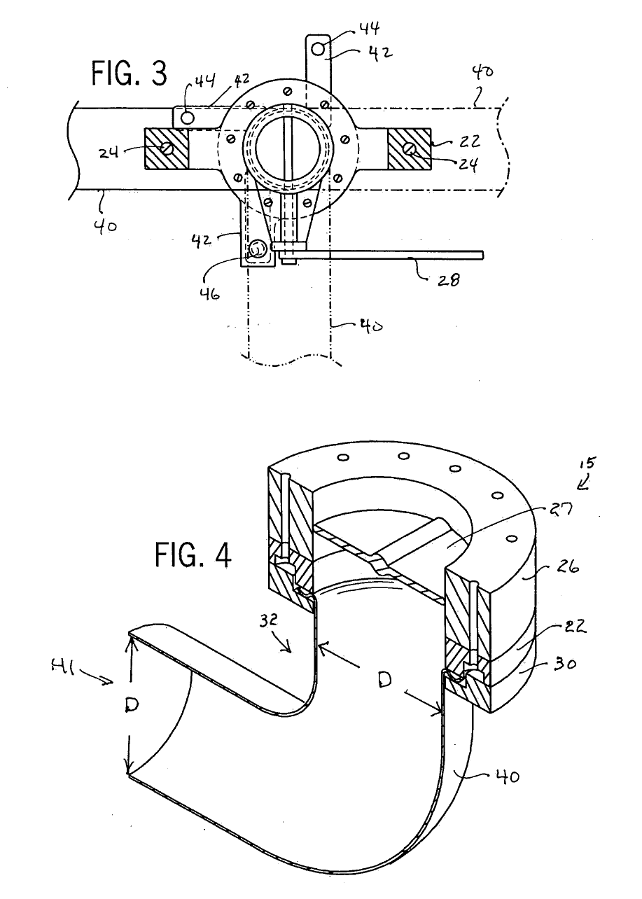

A chute 40 is coupled to the swivel 30 and is configured to pivot in an arc to any side of the container 16 (See FIG. 2). The chute 40 is tubular and defines an outlet opening 41. The cross-section of the chute 40 can be any convenient configuration, such as circular or rectangular (such as a square). The illustrations depict a circular cross-section for the chute 40 having a constant diameter D from the container 16 to the outlet opening 41. The inside diameter D of the chute can range from six inches to twelve inches and larger.

The apparatus 20 for discharging fluid from the container 16 is orientated in a substantially horizontal aspect relative to the container 16 and typically is located at a central location along the width of the container 16 (See FIG. 1).

The chute 40 can be pivoted in an arc to any side of the container 16 or orientated to the rear of the vehicle 10 as shown in FIG. 2. The swivel 30 is lockable in one of a plurality of positions which can be established by a lock-arm 42 having a bore 44 configured to receive a lock pin 46. An operator moves the chute to a selected position and inserts the lock pin 46 into the lock bore 44 of the lock arm 42 to fix the chute 40 in the desired orientation. It should be understood that the lock pin 46 can be coupled to an actuator such as an electric solenoid or a hydraulic cylinder and remotely controlled by the operator.

The chute 40 can also be configured with multiple members telescopically arranged to extend in the direction away from the apparatus 20. The chute 40 can be composed of material such as metal, steel or aluminum, or composite material having sufficient strength and durability for its intended use.

A typical operation of the apparatus for discharging fluid from the container involves positioning the vehicle 10 at a location designated for the discharge of the fluid. Moving the chute from a storage location beneath a portion of the container 16 to a discharge position and locking the chute with the lock pin 46 and lock arm 42 at the desired position. If the chute 40 is telescopic, extending the chute to a preselected extension. An operator then manipulates the valve handle 28 to open the valve 26 to discharge any fluid in the container. The valve can have several open positions other than fully opened as determined by the operator of the apparatus 20 and with appropriate stops configured in the valve mechanism.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature

Thus there is provided an apparatus for discharging fluid from a container wherein the chute is pivotable in an arc to any side of the container. While the embodiments illustrated in the figures and described above are presently preferred, it should be understood that these embodiments are offered by way of example only. The invention is not intended to be limited to any particular embodiment but is intended to extend to various modifications that nevertheless fall within the scope of the appended claims. For example, it is also contemplated that the apparatus be configured to dispense dry materials such as grain or gravel. Additional modifications will be evident to those with ordinary skill in the art.

What is claimed is:

1. A fluid handling vehicle comprising:
a tank for storing at least 1000 gallons of fluid, the tank including a discharge port configured to permit at least 800 gallons per minute of fluid flow from the port when the fluid flow is caused by gravity; and
a rotating chute coupled to the port configured to permit directing fluid flow in a range of directions relative to the tank wherein at least two of the directions are defined by rotating the chute in at least two positions offset from each other by at least 145 degrees.

2. The vehicle of claim 1, wherein the port is nominally circular having an inside diameter of at least six inches.

3. The vehicle of claim 2, wherein the chute includes an elbow with an elbow angle between 75 degrees and 90 degrees and having a nominally circular cross-section with an inside diameter of at least six inches.

4. The vehicle of claim 1, wherein the chute is locked in each position.

5. The vehicle of claim 1, wherein the chute is telescopic.

6. The vehicle of claim 1, wherein the port is nominally circular having an inside diameter range of six inches to twelve inches.

7. The vehicle of claim 1, wherein the port is configured to permit at least 1700 gallons per minute of fluid flow from the port.

8. The vehicle of claim 1, wherein the chute has a nominally circular cross-section with an inside diameter of at least ten inches

9. An apparatus for discharging fluid from a container, the apparatus comprising:
a mounting member coupled to the container;
a valve coupled to the mounting member and selectively in fluid communication with the container;
a swivel, including a single ninety-degree elbow member, coupled to the mounting member and the valve; and
a chute coupled to the swivel, wherein the chute is pivotable in an arc to any side of the container.

10. The apparatus of claim 9, wherein the valve is orientated in a substantially horizontal aspect relative to the container.

11. The apparatus of claim 9, wherein the chute is tubular and defines an outlet opening.

12. The apparatus of claim 11, wherein the cross-section of the chute from the container to the outlet opening is maintained.

13. The apparatus of claim 9, wherein the container is coupled to a vehicle.

14. The apparatus of claim 9, wherein the swivel is configured to lock in one of a plurality of positions.

15. The apparatus of claim 9, wherein the chute is telescopic.

16. The apparatus of claim 13, wherein the chute, when in a sideways extending position, extends beneath a portion of the container for storage.

17. The apparatus of claim 9, wherein the valve is a butterfly valve.

18. The apparatus of claim 13, wherein the vehicle is a tanker truck.

19. A vehicle comprising:
a support structure;
a plurality of wheels coupled to the support structure with at least two of the wheels steerable;
a container mounted on the support structure; and
an apparatus for discharging fluid from the container, the apparatus comprising:
a mounting member coupled to the container;
a valve coupled to the mounting member and selectively in fluid communication with the container;
a swivel, including a ninety-degree elbow member, coupled to the mounting member and the valve; and
a chute coupled to the swivel, wherein the chute is pivotable in an arc to any side of the container.

20. The vehicle of claim 19, wherein the valve is orientated in a substantially horizontal aspect relative to the container.

21. The vehicle of claim 19, wherein the chute is tubular and defines an outlet opening.

22. The vehicle of claim 21, wherein the cross-section of the chute from the container to the outlet opening is maintained.

23. The vehicle of claim 19, wherein the swivel is configured to lock in one of a plurality of positions.

24. The vehicle of claim 19, wherein the chute is telescopic.

25. The vehicle of claim 19, wherein the chute, when in a sideways extending position, extends beneath a portion of the container for storage.

26. The vehicle of claim 19, wherein the valve is a butterfly valve.

27. The vehicle of claim 19, wherein the vehicle is a tanker truck.

28. The vehicle of claim 19, including an power source coupled to at least one wheel to drive the vehicle along a surface.
